(19) United States
(12) Patent Application Publication
(10) Pub. No.: US 2014/0229823 A1
(43) Pub. Date: Aug. 14, 2014

(54) DISPLAY APPARATUS AND CONTROL METHOD THEREOF

(71) Applicant: SAMSUNG ELECTRONICS CO., LTD., Suwon-si (KR)

(72) Inventors: Sung-hyun CHO, Seoul (KR); June-geol KIM, Hwaseong-si (KR); Hee-seon PARK, Seoul (KR)

(73) Assignee: SAMSUNG ELECTRONICS CO., LTD., Suwon-si (KR)

(21) Appl. No.: 14/178,760

(22) Filed: Feb. 12, 2014

(30) Foreign Application Priority Data
Feb. 13, 2013 (KR) 10-2013-0015457

(51) Int. Cl. G06F 17/24; G06F 3/0488; G06F 3/0484

(52) U.S. Cl. CPC G06F 17/24; G06F 3/0484; G06F 3/0488
USPC 715/255

(57) ABSTRACT

A display apparatus and control method are provided. The apparatus includes: a display; a communicator configured to communicate with an external device that provides predetermined original content; a content processor configured to implement and process the original content provided from the external device through the communicator in order to display an image on the display; and a controller configured to edit the original content by a user and to generate edited content independent of the original content, instead of updating an edition result directly to the original content.

### CROSS-REFERENCE TO RELATED APPLICATION

This application claims priority from Korean Patent Application No. 10-2013-0015457, filed on Feb. 13, 2013 in the Korean Intellectual Property Office, the disclosure of which is incorporated herein by reference, in its entirety.

### BACKGROUND

1. Field

Apparatuses and methods consistent with the exemplary embodiments relate to a display apparatus capable of processing various forms of content data in order to display content images, and a control method thereof. More particularly, the exemplary embodiments relate to a display apparatus that is provided with edited content generated by editing original content with various methods and implements the edited content, and a control method thereof.

2. Description of the Related Art

A display apparatus is a device that includes a display panel which displays an image and processes content data received from the outside or stored therein, in order to display content images. Various forms of display apparatuses may basically be provided to provide images, wherein a display apparatus available to general users may be configured as a TV, a computer monitor, a portable multimedia player, a table computer, a mobile phone, or the like.

A display apparatus is capable of processing and displaying content data, such as a video, a game, a webpage, and an application, and has recently provided a user with an e-book as a publication in data form displayed thereon as an image.

Generally, an e-book is provided in a state as published by a publisher. For example, an e-book is displayed on a display apparatus in the same content of texts and illustrations, form, font, style and arrangement on each page as determined by a publisher. Thus, users simply implement and display the e-book as provided by the publisher and have difficulty in modifying/improving the e-book and/or sharing an edited version obtained by modifying/improving the e-book with other users.

Further, even though a content provider provides an edited version of the e-book generated by editing an original version, users may experience the inconvenience of downloading the edited version with data quantity that is similar to or greater than that of the original version.

### SUMMARY

The foregoing and/or other aspects may be achieved by providing a display apparatus including: a display; a communicator configured to communicate with an external device that provides predetermined original content; a content processor configured to implement and process the original content provided from the external device through the communicator in order to display an image on the display; and a controller configured to edit the original content by a user and to generate edited content independent of the original content, instead of updating an edited result directly to the original content.

The controller may transmit to the external device the generated content which is edited content so that the external device selectively provides the edited content to a first display apparatus based on whether the first display apparatus is authorized to receive the original content, in response to the first display apparatus connecting to the external device for communications.

The edited content may include an event that occurs by the user and corresponds to a predetermined object of the original content and data related a preset action by occurrence of the event, and the controller may be configured to import and display the object from the original content when the edited content is implemented, and may be configured to control the object in order to perform the action in response to the event occurring with the object being displayed.

The object may include a content image displayed on the display and at least one of a text, may include an image and a multimedia component in the content image.

The event may occur through an input or manipulation of the user, with respect to the display apparatus.

The display may include a touch-screen, and the event may include at least one of touching, dragging and tapping motions of the user on the display, a gesture by the user, and a voice command of the user.

The action may include at least one of a modification, a visual effect, a multimedia effect and a three-dimensional rendering with respect to the object.

The edited content may include an address of the object in the original content, instead of including the object, so as to import the object from the original content.

The controller may display a user interface (UI) image which includes an implementation image of the original content, and may receive the edited content from the server in response to reception of the edited content being selected through the implementation image on the UI image.

The first display apparatus may be not provided with the edited content from the external device in response to the first display apparatus not being authorized to receive the original content from the external device.

The external device may include a server.

Another aspect of the exemplary embodiments may be achieved by providing a method of controlling a display apparatus including: receiving predetermined original content provided from an external device; and controlling the editing by a user of the original content and to generate edited content independent of the original content, instead of updating an editing result directly to the original content.

The control method may further include transmitting the generated edited content to the external device so that the external device selectively provides the edited content to a first display apparatus based on whether or not the first display apparatus is authorized to receive the original content in response to the first display apparatus connecting to the external device for communications.

The edited content may include a user event that corresponds to a predetermined object of the original content and data related to a preset action by occurrence of the event, and the control method may further include importing and displaying the object from the original content in response to the edited content being implemented, and controlling the object to perform the action in response to the event occurring with the object being displayed.

The object may include a content image and at least one of a text, an image and a multimedia component in the content image.

The action may include at least one of a modification, a visual effect, a multimedia effect and three-dimensional rendering with respect to the object.

The edited content may include an address of the object in the original content, instead of including the object, so as to import the object from the original content.

An aspect of an exemplary embodiment may further provide a display apparatus including: a content processor configured to implement and process an original content in order to display an image; and a controller configured to edit the original content and to generate edited content independent of the original content, instead of directly updating an editing result to the original content. The display apparatus may further include a display.

The display apparatus may further include: a communicator configured to communicate with an external device that provides the predetermined original content. The original content may be provided from the external device through the controller.

The external device may include the edited content to a first display apparatus based on whether the first display apparatus is authorized to receive the original content, in response to the first display apparatus being connected to the external device for communications.

The edited content may include a user event that corresponds to a predetermined object of the original content and data related to a preset action by occurrence of the event.

The edited content may include an address of the object in the original content, instead of including the object, so as to import the object from the original content.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 illustrates a display apparatus according to an exemplary embodiment.

FIG. 2 is a block diagram which illustrates a configuration of the display apparatus of FIG. 1.

FIG. 3. illustrates implementation of an application and a content image on the display apparatus of FIG. 1.

FIGS. 4 to 6 illustrate user interface (UI) images displayed on the display apparatus of FIG. 1, which are provided with edited content from a server.

FIG. 7 illustrates a principle of generating edited content by editing a particular object of original content.

FIG. 8 is a flowchart which illustrates a process of displaying an object in response to the display apparatus of FIG. 1 implementing the edited content generated as in FIG. 7.

FIG. 9 illustrates an initial image of edited content displayed on the display apparatus of FIG. 1.

FIGS. 10 to 14 illustrate action-reflected objects of the initial image of the edited content in response to the display apparatus of FIG. 1 implementing the edited content.

### DETAILED DESCRIPTION OF EXEMPLARY EMBODIMENTS

Below, exemplary embodiments will be described in detail with reference to accompanying drawings so as to be easily understood by a person having ordinary knowledge in the art. The exemplary embodiments may be embodied in various forms without being limited to the exemplary embodiments set forth herein. Descriptions of well-known parts are omitted for clarity and conciseness, and like reference numerals refer to like elements throughout.

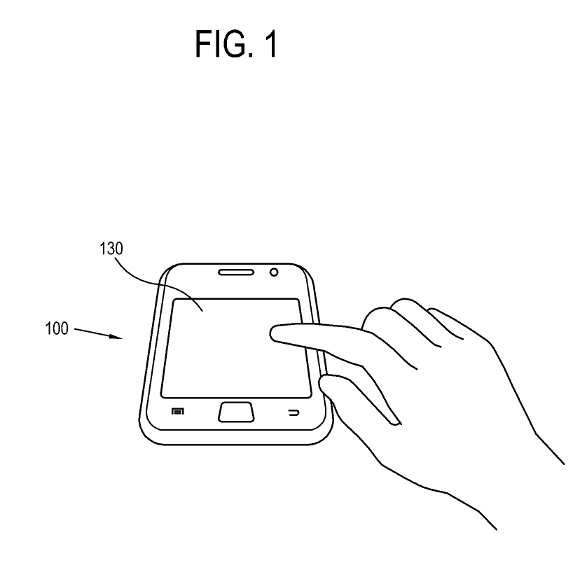

FIG. 1 illustrates a display apparatus 100 according to an exemplary embodiment.

As shown in FIG. 1, the display apparatus 100 according to a present embodiment is configured as a portable mobile multimedia player carried by a user, such as a tablet computer or a mobile phone. However, such an example is provided only for illustrative purposes and any display apparatus 100 capable of displaying content images based on various kinds of content data may be used.

The display apparatus 100 includes a display 130 configured to display an image. The display 130 is configured as a touch-screen that enables a user to input user intent to the display apparatus 100 by touching, dragging or tapping a user interface (UI) image displayed on the display 130.

In addition to the foregoing examples, various methods of conducting a preset input to the display apparatus 100 based on a user manipulation may be used, for instance, inputting a voice command based on an uttered speech of a user, a user gesturing, and a user moving the display apparatus 100.

In an exemplary embodiment, inputting user intent to the display apparatus 100 via a plurality of interfaces of the display apparatus 100 is defined as an event. That is, an event occurs through an action by a user.

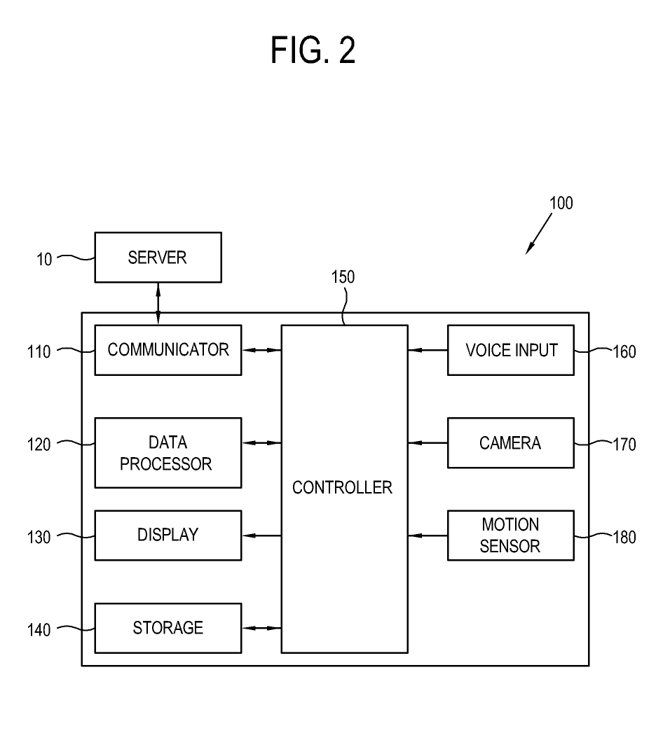

Hereinafter, a configuration of the display apparatus 100 will be described in detail with reference to FIG. 2.

FIG. 2 is a block diagram which illustrates the configuration of the display apparatus 100.

As shown in FIG. 2, the display apparatus 100 includes a communicator 110 configured to communicate with a server 10, a data processor 120 configured to process data, display 130 to display an image based on the data processed by the data processor 120, a storage 140 configured to store the data, and a controller 150 configured to control operations of all components of the display apparatus 100.

Further, the display apparatus 100 includes, as an interface to generate an event which corresponds to an input from the user, a voice input 160 configured to input user speech, a camera 170 configured to photograph an external environment of the display apparatus 100, including the user, and a motion sensor 180 configured to detect a motion of the display apparatus 100. In addition, various configurations of interfaces may be adopted, for example, a touch-screen may be implemented as the display 130 or a button (not shown) on an outside of the display apparatus 100 may be manipulated by the user.

The communicator 110 connects to a local/wide-area network to conduct two-way communications with various kinds of external devices (not shown), including the server 10. The communicator 110 conducts communications in accordance with diverse wire-based/wireless communication protocols. For example, the communicator 110 connects to the server 10 via an access point (AP) in accordance with a wireless communication protocol, for example, Wi-Fi®, and exchanges data with server 10.

The data processor 120 processes data received through the communicator 110 or stored in the storage 140 according to various preset processes. The data processor 120 may be configured as an integrated multi-functional component, such as a system on chip (SOC), or as a processing board (not shown) formed by mounting components which independently conduct individual processes on a printed circuit board and embedded in the display apparatus 100.

The data processor 120 operates, for example, to process an application stored in the storage 140 to be run and outputs an image signal relevant to the application to the display 130 so that an image of the application may be displayed on the display 130. Further, the data processor 120 conduct processing such that the application operates based on an event occurring through an interface and an image is displayed according to the operation of the application.

The display 130 is configured to display an image based on an image signal/image data output from the data processor 120. The display 130 may be configured in various display modes using liquid crystals, plasma, light emitting diodes, organic light emitting diodes, a surface conduction electron emitter, a carbon nano-tube, nano-crystals, or the like, without being limited thereto.

The display 130 may further include an additional element, depending on a display mode thereof. For example, in a display mode using liquid crystals, the display unit 130 may include a liquid crystal display (LCD) panel (not shown), a backlight (not shown) to provide light to the panel, and a panel drive board (not shown) to drive the panel.

Further, the display 130, according to an exemplary embodiment may include a touch-screen, in which the user may transmit a preset command to the controller 150 by touching a UI image (not shown) displayed on the display 130.

The storage 140 stores various types of data according to control of the controller 150. The storage 140 is configured as a nonvolatile memory, such as a flash memory and a hard disk drive. The storage 140 is accessed by the controller 150 and the data processor 120, and the data stored in the storage 140 may be read/recorded/revised/deleted/updated.

The controller 150 includes a central processing unit (CPU) mounted on the processing board (not shown) forming the data processor 120 and controls operations of each component of the display apparatus 100 including the data processor 120. In response to the occurrence of a user event, the controller 150 determines or calculates an operation of the display apparatus 100 which corresponds to the event and outputs a control signal or control command to each component of the display apparatus 100, in order to carry out the determined operation.

The voice input 160 is configured as a microphone and detects various sounds generated in the external environment of the display apparatus 100. Sounds detected by the voice input 160 include speech uttered by the user and sounds generated by various factors other than the user.

The camera 170 detects and takes a picture of the external environment of the display apparatus 100. The camera 170 may take a picture of the external environment at a particular time in order to generate a still image or takes pictures for a preset period of time in order to generate a moving image. For example, the camera 170 detects a motion of the user waving a hand in front of the camera 170 and reports the motion to the controller 150 so that the controller 150 conducts an operation which corresponds to the result of the detection.

The motion sensor 180 detects a motion of the display apparatus 100 held by the user, for example, a slope or a change of the display apparatus 100 based on a current posture of the display apparatus 100. The motion sensor 180 detects a movement of the display apparatus 100 in a preset triaxial coordinate system; that is, a three-dimensional coordinate system with width, length, and height or x, y, and z-axes. To this end, the motion sensor 180 may be configured as a gyro sensor, an inertial sensor, or an acceleration sensor.

With this configuration, the controller 150 stores content data provided from the server 10 in the storage 140 and runs the stored content data, thereby displaying an image of the content data on display 130.

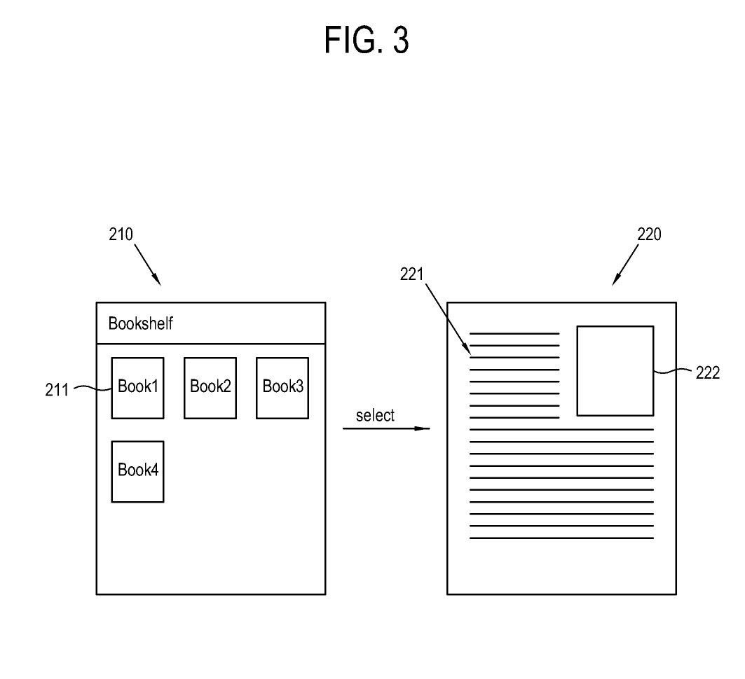

FIG. 3. illustrates implementation of an application and content images 210 and 220 on the display apparatus 100. An exemplary embodiment illustrates that an e-book application is implemented to display as a kind of content data an image of an e-book that is a digital book. However, the foregoing example is provided for illustrative purposes only, without limiting the scope of the exemplary embodiment.

As shown in FIG. 3, when the controller 150 implements the e-book application, an implemented image 210 of the application (also referred to as an application image) is displayed on display 130. The application enables at least one e-book content to be imported and implemented. The imported e-book content refers to content stored in the storage 140 or content purchased by the user in order to obtain a right to be provided from the server 10. Although the exemplary embodiment illustrates the imported e-book content that is stored in the storage 140, the imported e-book may be received as necessary from the server 10 and may be stored in the storage 140.

The application image 210 presents a selection image 211 for selecting at least one e-book content imported at a present point. The selection image 211 may be an icon or an image, such as a cover, which corresponds to the content of each e-book.

In response to the user clicking any one selection image 211 on the application image 120, the controller 150 displays the e-book content image 220 of the selection image 211 on display 130.

The e-book content includes at least one data of each page among a text, an image and a multimedia component. The multimedia component may include a video or a sound component. Thus, the e-book content image 220 visually presents a text 221 or an image 222 of a page of the e-book content which is currently displayed. A visual component forming the currently displayed e-book content image 220, such as the text 221 and the image 222, is defined as an object 221 or 222.

Basically, the e-book content image 220 presents the intact objects 221 and 222 as provided by a publisher or a content provider. However, e-book content in data form may be provided to different users via modification and improvement in various forms. E-book content provided intact as provided a publisher or content provider is defined as original content, and content generated by modifying, improving, or editing the original content by different users or content providers is defined as edited content.

The edited content may be generated by the content provider that provides the original content or by any provider. For example, a user of the original content or other content providers. The edited content may be provided by the server 10 that provides the original content or by a separate server (not shown) in association with the server 10.

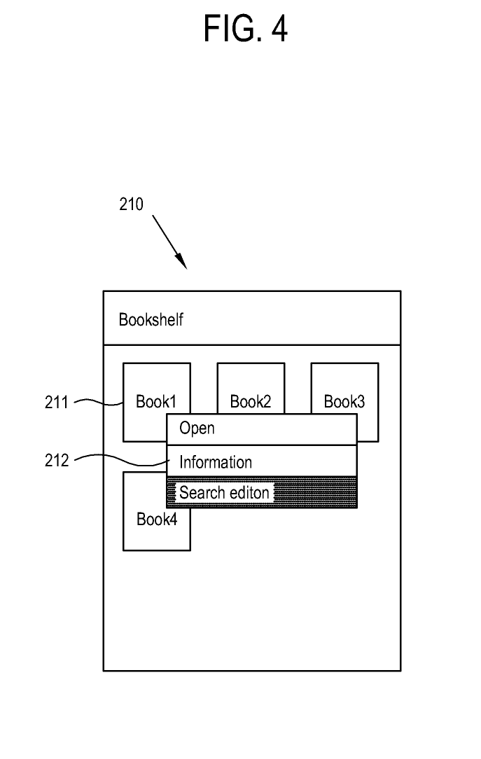

FIGS. 4 to 6 illustrate UI images of the display apparatus of FIG. 1 displays to be provided with edited content from the server 10.

As shown in FIG. 4, with the application image 210 being displayed, the user touches the selection image 211 of desired original content to display a popup menu 212 which is relevant to the original content. Any option may be selected on the popup menu 212, for example, an option to display original content and an option of information related to the original content.

The user may select “search edition” on the popup menu 212, that is, an option of searching for edited content of the original content.

In response to a search for the edited content being selected and determined by the user, the display apparatus 100 connects to the server 10 for communications and requests a list of edited contents which are relevant to the original content.

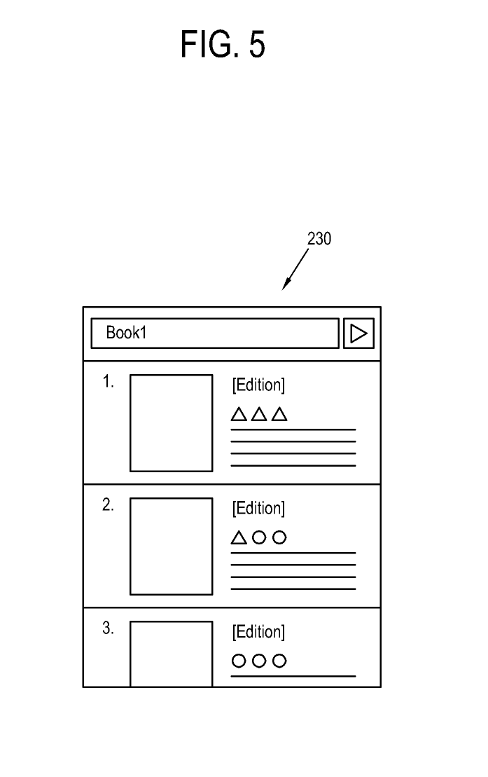

As shown in FIG. 5, the server 10 provides the list of the edited contents of the original content, for example, “Book 1,” to the display apparatus 100, in response to the request from the display apparatus 100. The display apparatus 10 displays a list image 230 of the edited contents provided from the server 10.

The list image 230 provides the edited contents which are relevant to the original content provided for selection by the server 10. The user may select desired edited content from the list image 230.

The display apparatus 100 receives from the server 10 the edited content selected from the list image 130 10 and stores the edited content.

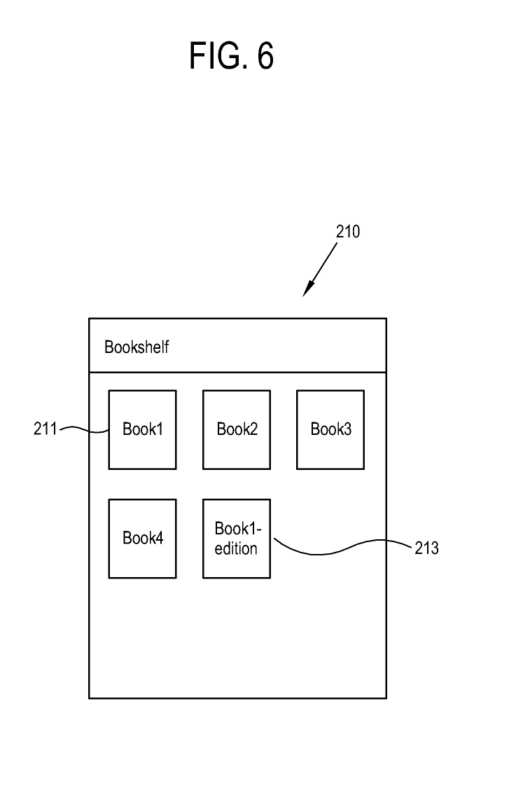

As shown in FIG. 6, the display apparatus imports the edited content received from the server into the application so that the edited content is implemented by the application. In response to the edited content being imported into the application, a selection image 213 of the edited content “Book1-edited content” is displayed on the application image 210, separately from the original content “Book1.”

In response to the user clicking the selection image 213, the display apparatus 100 displays the edited content “Book1-edited content” instead of the original content “Book1.”

The display apparatus 100 may use various methods to receive the edited content, without being limited to the foregoing example. In an exemplary embodiment, in response to the original content is determined to be stored in the display apparatus 100, the display apparatus 100 may be provided with the edited content from server 10 and may implement the edited content. In response to the original content determined to not be stored in the display apparatus 100, the display apparatus 100 is not provided with the edited content of the original content from the server 10 for implementation; two reasons for which will be described as follow.

First, in response to the original content being provided at a cost to the user, it is inappropriate to provide the edited content free of charge. Further, even though the edited content is provided at a cost, it may be unsuitable for a content provider of the original content to distribute the edited content instead of the original content.

Second, although the edited content is generated based on the original content in an exemplary embodiment, the edited content does not include all data or details of the original content but include necessary data imported from the original content. Thus, the original content is needed to implement the edited content.

Alternatively, in response to the original content not being stored in the display apparatus 100, but the display apparatus 100 being authorized to provide the original content from the server 10, the display apparatus 100 may be also provided with the edited content of the original content. In this case, the display apparatus 100 may also receive the original content and the edited content together from server 10.

On the contrary, in response to the display apparatus 100 not being authorized to provide the original content from server 10, the display apparatus 100 may not receive the edited content of the original content from the server 10. To receive the edited content from the server 10, the display apparatus 100 first obtains authority to receive the original content.

Hereinafter, a principle of displaying an object of edited content in response to the display apparatus 100 implementing the edited content and displays an image of a particular page of the edited content.

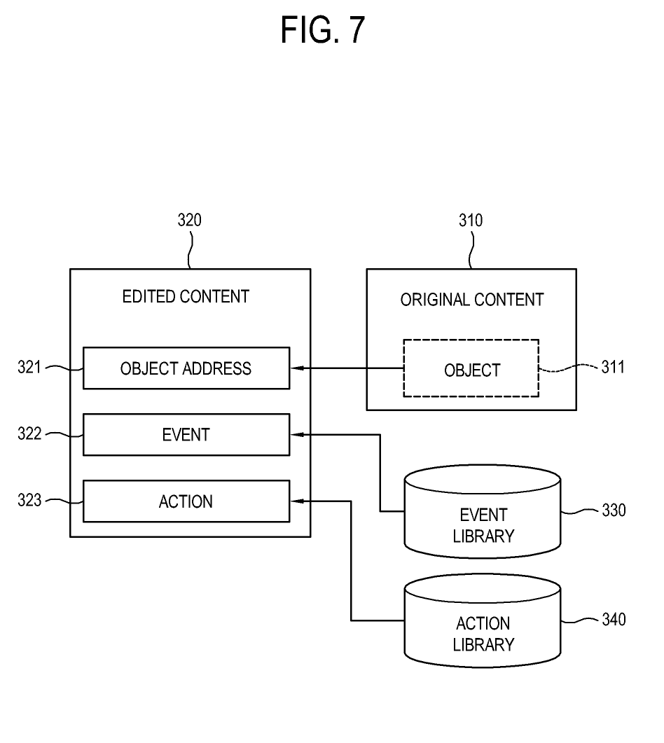

FIG. 7 illustrates a principle of generating edited content 320 by editing a particular object 311 of original content 310.

As shown in FIG. 7, one object 311 from among a plurality of objects included in the original content 310 is edited, thereby generating the edited content 320.

A content creator reads information related to an address 321 of the object 311 in the original content 310 in order to choose the object 311 to be edited in the original content 310. The object address 321 may include information in any form in order to find the object 311 from the original content 310; for example, an identifier (ID) of the object 311 in the original content 310.

The content creator determines an event 322 from a preset event library 330. The event 322 refers to any motion that occurs through an input or manipulation of the user with respect to the display apparatus 100. For example, the event library 330 may include the event 322, such as touching, dragging and tapping motions of the user on the display 130, a voice command based on uttered speech of the user through the voice input 160, a gesture of the user detected by the camera 170, and a movement of the display apparatus 100 made by the user.

Further, the content creator determines an action 323 from a preset action library 340. The action 323 refers to a motion of the object 311 by occurrence of the event 322. For example, the action library 340 may include the action 323, such as a change in size and form of the object 311, a change in visual effects including color, frame, brightness, contrast and noise, a change in multimedia effects including video playback and audio addition, and 3D rendering of a two-dimensional image.

The content creator binds the object address 321, the event 322, and the action 323, thereby generating the edited content 320 with respect to the particular object 311 of the original content 310. In this manner, the content creator edits the plurality of objects 311 of the original content 310 and combines edited results into one edited content 320, thereby generating and providing new edited content 320 based on the content creators intentions regarding the user.

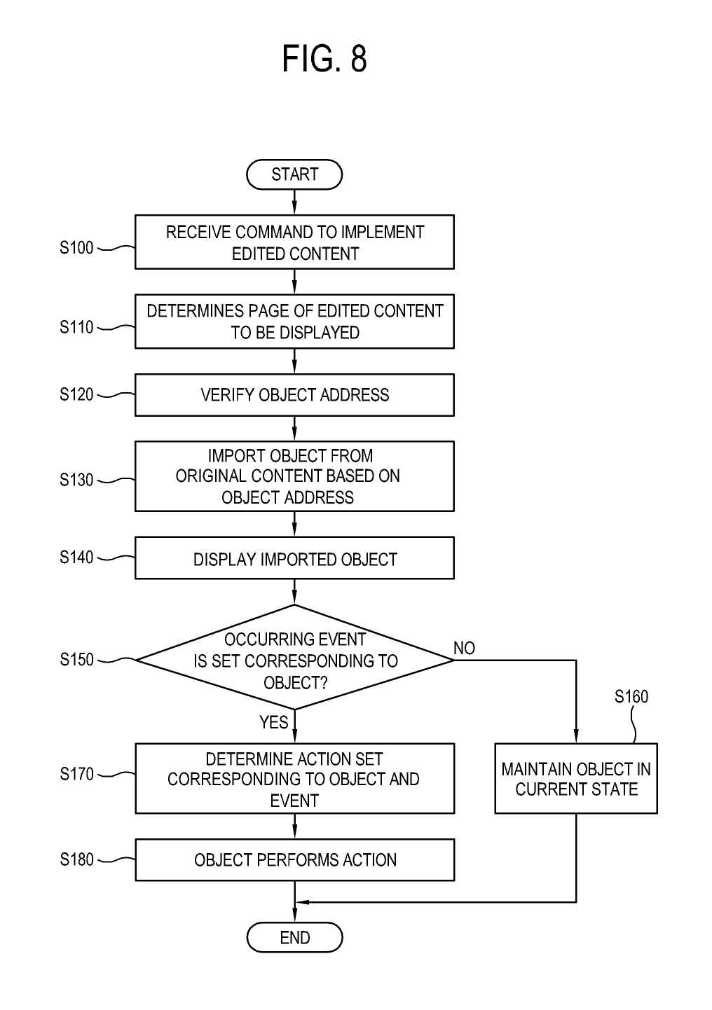

FIG. 8 is a flowchart which illustrates a process of displaying an object in response to the display apparatus 100 implementing the edited content, as generated in FIG. 7.

As shown in FIG. 8, the display apparatus 100 receives a command to implement edited content (S100) and then determines a page of the edited content to be displayed (S110).

The display apparatus 100 verifies an object address of an object to be displayed on the determined page (S120) and imports the object from original content based on the object address (S130). The display apparatus 100 displays the imported object (S140).

In response to a preset event occurring with the object being displayed, the display apparatus 100 determines whether the event is an event set which corresponds to the object in the edited content (S150).

In response to the event being not an event set which corresponds to the object, the display apparatus 100 maintains the object being displayed, as is (S160).

In response to the event being an event set which corresponds to the object, the display apparatus 100 determines an action set which corresponds to the object and the event (S170). The display apparatus 100 then uses the object to perform the determined action.

As described above, the edited content does not include an object, unlike the original content. In response to edited content including an object, data quantity of edited content is similar to or greater than that of the original content. On the other hand, the edited content according to the exemplary embodiment includes the address of the object in order to import the object from the original content, instead of including the object.

Thus, the original content is needed to implement the edited content. However, data quantity of the edited content is remarkably smaller than that of the original content and thus is received from the server 10 at a relatively higher speed than the original content.

As described above, according to the exemplary embodiment, the user may generate and provide edited content to other users by editing original content without modifying the original content. Further, static content may be modified into interactive or dynamic content for use and content modified/improved/edited by the user or content provider may be shared and collaborated with other users, thereby generating and providing new or improved content based on the original content.

Further, not only the content provider of the original content but general users or other content providers may also provide the edited content to other users by running their own stores/shops in a content shop provided by the server 10. Moreover, the edited content may be shared in file or webpage link forms between users through a social networking service (SNS) and email as well as through sale via shopping malls/stores/shops. Alternatively, the edited content may be stored in a shared area of a cloud in a network, and a plurality of users may communally edit and update the edited content.

Hereinafter, an illustrative case will be described where an action of an object is carried out by occurrence of an event by the user in response to the display apparatus 100 implementing edited content. An exemplary embodiment is not limited to the following examples, but may be modified in various manners.

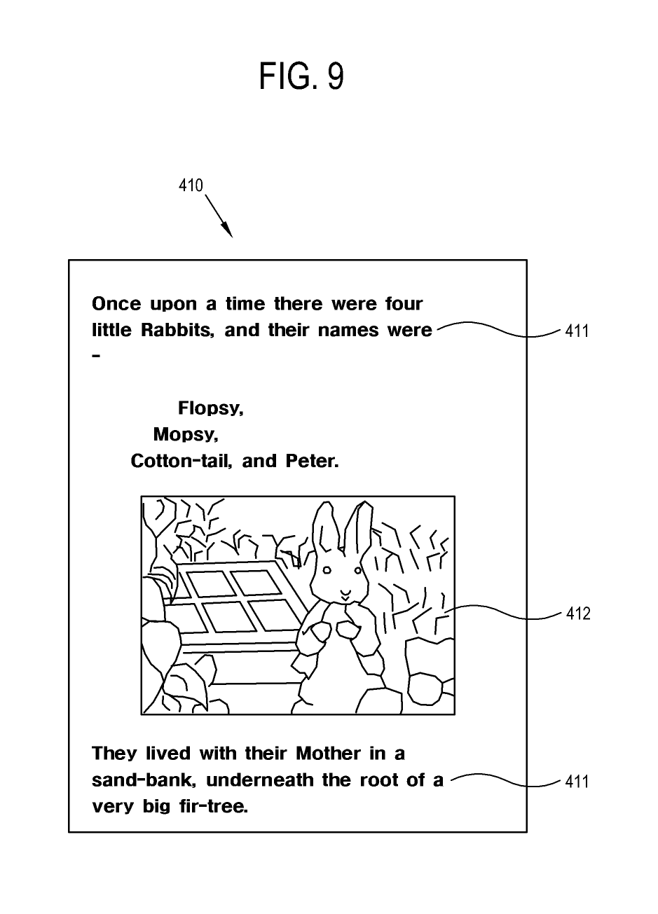

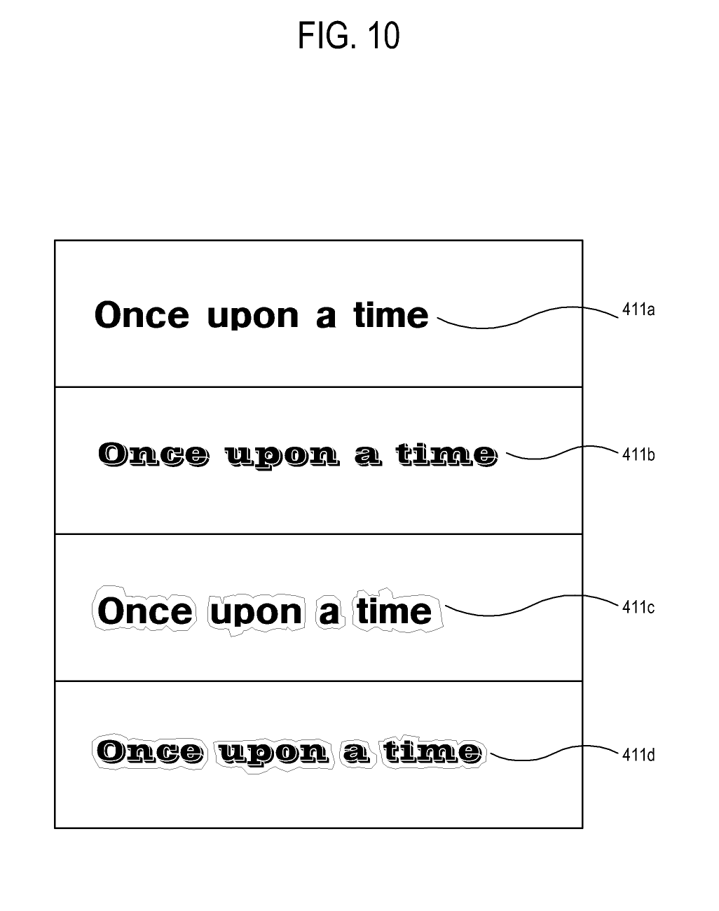

FIG. 9 illustrates an initial image 410 of edited content, and FIGS. 10 to 14 illustrate action-reflected objects of the initial image 410 of the edited content in response to the display apparatus 100 implementing the edited content.

As shown in FIG. 9, the image 410 of the edited content (also referred to as an “edited content image”) includes one or more objects 411 and 412 on one page, wherein the objects 411 and 412 include, for example, a text 411 and an image 412. The foregoing configuration of the objects 411 and 412 is provided for illustrative purposes only, and the objects 411 and 412 forming the image 410 of the edited content may be variously modified in kind, arrangement and quantity.

The initial image 140 of the edited content where any action is not carried out is the same as an image of original content.

In response to a user touch being set as an event with respect to the objects 411 and 412 of the edited content image 410, the objects 411 and 412 perform various actions in response to the user conducting a touch action. Alternatively, in response to an event being set to occur at a time in order to display the edited content image 410, a preset action-reflected image may be automatically displayed on the display apparatus 100 at the time to display the edited content image 410.

The action-reflected image reflects diverse visual effects on the objects 411 and 412.

As shown in FIG. 10, in response to a target object being, for example, a text 411a, text images 411b, 411c and 411d as the text 411a various reflecting actions may be displayed on display apparatus 100. FIG. 10 shows part of the object 411, instead of the entire edited content image 410 shown in FIG. 9, in order to clearly show the visual effects on the text images 411b, 411c and 411d.

A text image 411b may reflect a 3D action, such as a drop shadow, in order to emphasize the text 411a against the background.

Further, a text image 411c reflects a neon or glowing effect on the text 411a. A neon effect refers to flowing of the text 411a.

Also, a test image 411d reflects both a drop shadow and a neon effect on the text 411a. That is, a plurality of preset actions may be simultaneously applied to the text 411a, instead of each individual action.

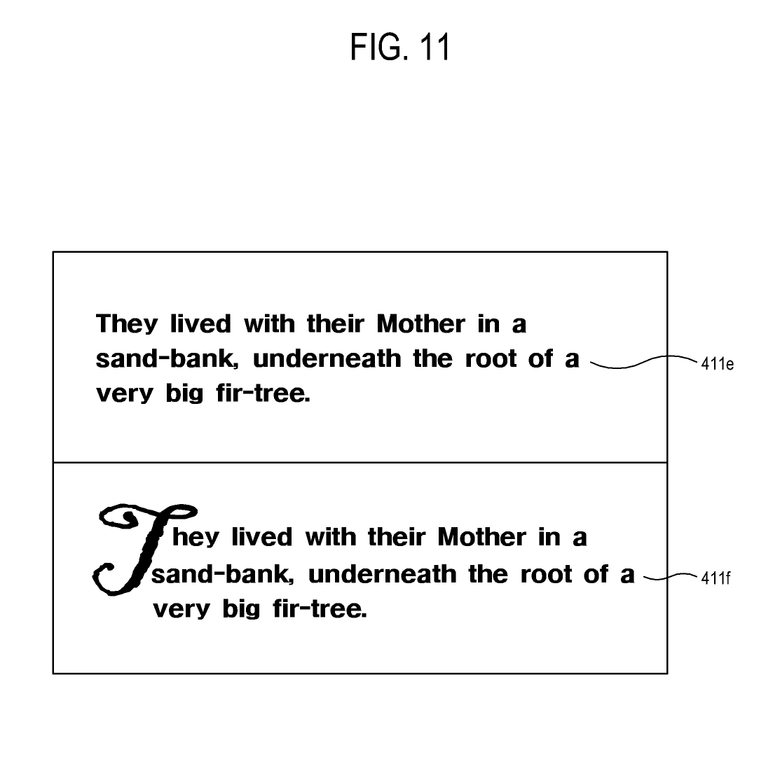

As shown in FIG. 11, in response to the target object being a single paragraph 411e, an action-reflected text image 411f may include a first letter of the paragraph 411e which is adjusted to be relatively large or decorated. Accordingly, the user may easily distinguish the paragraph.

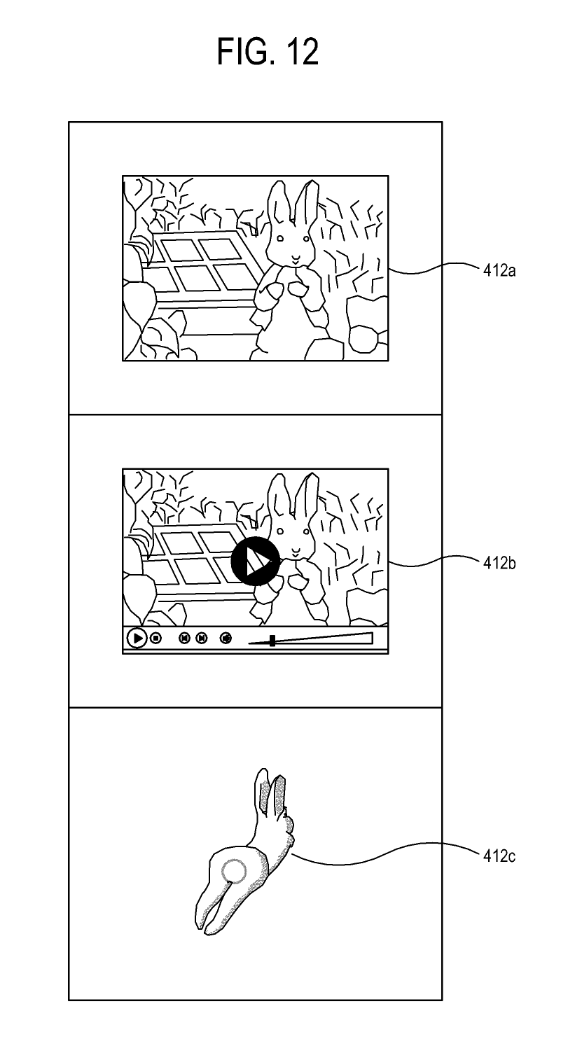

As shown in FIG. 12, the target object may be an image 412a. In response to a preset event occurring with the edited content image 410 being displayed, the image 412a may be displayed, reflecting various actions as follows.

For instance, the image 412a may be replaced with a new video 412b to be deployed in response to the event occurring. The display apparatus 100 may display various control UIs for simultaneously playing data of the video 412b with displaying of the video 412b.

Alternatively, the image 412a may be linked to additional data, such as audio data. Accordingly, the audio data link to the image 412a may be played in response to the event occurring.

In addition, the 2D image 412a may be replaced with a 3D model 412c for display via rendering. The 3D model 412c may be generated for rendering by the display apparatus 100 by analyzing the image 412a or may be provided from server 10 to the display apparatus 100.

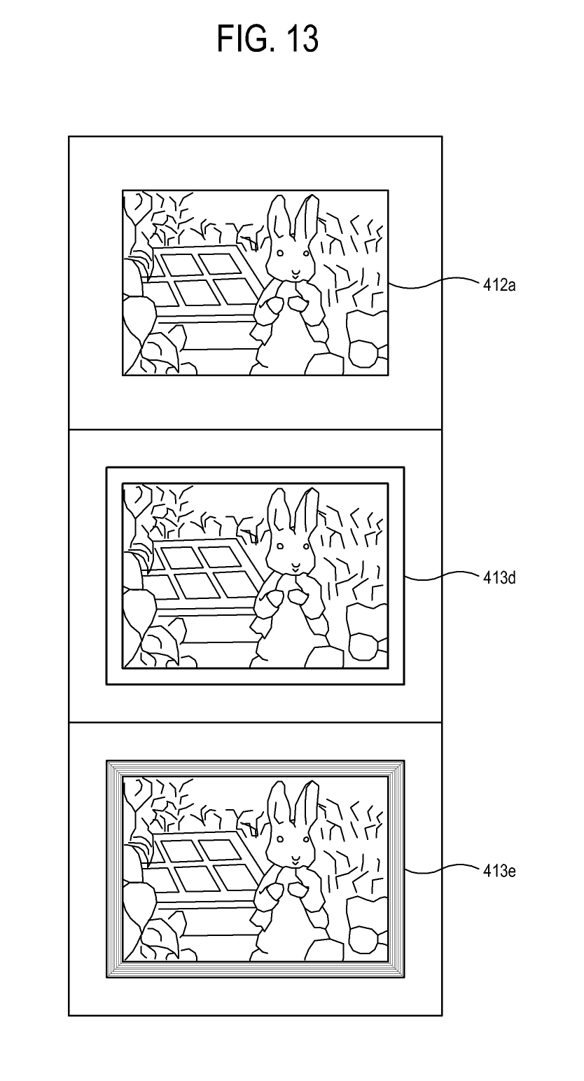

As shown in FIG. 13, various forms of frames may be applied to the image 412a. For instance, a simple-structure frame may be applied to the image 412a (413d), while a complicated-structure frame may be applied to the image 412a for display on the display apparatus 100 (413e).

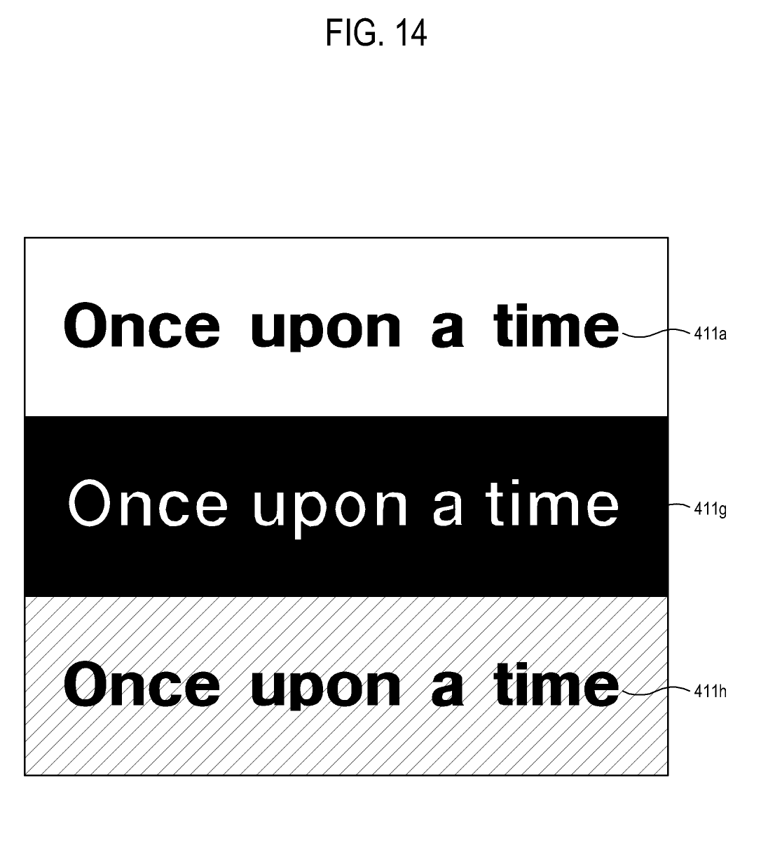

As shown in FIG. 14, the object 411a is a text that is displayed with black letters in a white background. An action-reflected object 411g may be displayed with white letters in a black background via an inversion of black and white, which enables the user to clearly identify the text 411a in a dark environment, such as at night.

Alternatively, an action-reflected object 411h may be displayed with a relatively reduced white color and a gray tone overall in the background, which is to reduce brightness of the image, resulting in decrease in power consumption of the display apparatus 100 to display the image.

As described above, various kinds of actions may be applied to the object.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a display;
a communicator configured to communicate with an external device that provides predetermined original content;
a content processor configured to implement and process the original content provided from the external device through the communicator in order to display an image on the display; and
a controller configured to edit the original content by a user and to generate edited content independent of the original content, instead of directly updating an editing result to the original content.

2. The display apparatus of claim 1, wherein the controller is configured to transmit the generated edited content to the external device so that the external device selectively provides the edited content to a first display apparatus based on whether the first display apparatus is authorized to receive the original content, in response to the first display apparatus connecting to the external device for communications.

3. The display apparatus of claim 2, wherein the edited content comprises a user event that corresponds to a predetermined object of the original content and data related to a preset action by occurrence of the event, and the controller is configured to import and display the object from the original content when the edited content is implemented, and control the object in order to perform the action in response to the event occurring with the object being displayed.

4. The display apparatus of claim 3, wherein the object comprises a content image displayed on the display and includes at least one of a text, an image and a multimedia component in the content image.

5. The display apparatus of claim 3, wherein the event occurs as a result of an input or manipulation by the user with respect to the display apparatus.

6. The display apparatus of claim 5, wherein the display comprises a touch-screen, and the event comprises at least one of touching, dragging and tapping motions of the user on the display, a user gesture and a user voice command.

7. The display apparatus of claim 3, wherein the action comprises at least one of a modification, a visual effect, a multimedia effect and three-dimensional rendering with respect to the object.

8. The display apparatus of claim 3, wherein the edited content comprises an address of the object in the original content, instead of comprising the object, so as to import the object from the original content.

9. The display apparatus of claim 2, wherein the controller is configured to display a user interface (UI) image comprising an implementation image of the original content, and receives the edited content from the server in response to reception of the edited content being selected through the implementation image on the UI image.

10. The display apparatus of claim 2, wherein the first display apparatus is not provided with the edited content from the external device in response to the first display apparatus not being authorized to receive the original content from the external device.

11. The display apparatus of claim 1, wherein the external device comprises a server.

12. A control method of a display apparatus comprising:
receiving predetermined original content provided from an external device; and
controlling the editing of the original content by a user and generating edited content independent of the original content, instead of directly updating to the original content a result of the editing.

13. The control method of claim 12, further comprising transmitting the generated edited content to the external device so that the external device selectively provides the edited content to a first display apparatus based on whether the first display apparatus is authorized to receive the original content in response to the first display apparatus connecting to the external device for communications.

14. The control method of claim 13, wherein the edited content comprises a user event that corresponds to a predetermined object of the original content and data related to a preset action by occurrence of the event, and the control method further comprises importing and displaying the object from the original content in response to the edited content being implemented, and controlling the object to perform the action in response to the event occurring with the object being displayed.

15. The control method of claim 14, wherein the object comprises a content image and at least one of a text, an image and a multimedia component in the content image.

16. The control method of claim 14, wherein the action comprises at least one of a modification, a visual effect, a multimedia effect and three-dimensional rendering with respect to the object.

17. The control method of claim 14, wherein the edited content comprises an address of the object in the original content, instead of comprising the object, so as to import the object from the original content.

18. A display apparatus comprising:
a content processor configured to implement and process an original content in order to display an image; and
a controller configured to edit the original content and to generate edited content independent of the original content, instead of directly updating an editing result to the original content.

19. The display apparatus of claim 18, wherein the external device provides the edited content to a first display apparatus based on whether the first display apparatus is authorized to receive the original content, in response to the first display apparatus being connected to the external device for communications.

20. The display apparatus of claim 18, wherein the edited content comprises a user event that corresponds to a predetermined object of the original content and data related to a preset action by occurrence of the event.

21. The display apparatus of claim 20, wherein the edited content comprises an address of the object in the original content, instead of comprising the object, so as to import the object from the original content.
